(19) United States
(12) Patent Application Publication
(10) Pub. No.: US 2026/0238135 A1
(43) Pub. Date: Aug. 13, 2026

(54) RESONANT CONVERTER, METHOD FOR SWITCHING BIDIRECTION OPERATION THEREOF AND DISTRIBUTED POWER SUPPLY SYSTEM

(71) Applicant: Delta Electronics (Shanghai) Co.,Ltd., Shanghai (CN)

(72) Inventors: Hong LIU, Shanghai (CN); Yuxin HAN, Shanghai (CN); Wen ZHANG, Shanghai (CN); Wenfei HU, Shanghai (CN); Baihui SONG, Shanghai (CN); Qiushi ZHANG, Shanghai (CN)

(21) Appl. No.: 19/461,677

(22) Filed: Jan. 27, 2026

(30) Foreign Application Priority Data
Feb. 12, 2025 (CN) 202510156818.0
Sep. 9, 2025 (CN) 202511286984.9

(51) Int. Cl. H02M 3/335; H02M 3/00

(52) U.S. Cl. CPC H02M 3/33584; H02M 3/01; H02M 3/33573

(57) ABSTRACT

Provided are a resonant converter, a method for switching bidirectional operation thereof and a distributed power supply system. The resonant converter includes a first switching circuit, a resonant network and a second switching circuit connected sequentially, the first switching circuit includes a first port and a second port, the second switching circuit includes a third port and a fourth port, the resonant network connected between the second port and the third port, the bidirectional operation includes a first operation mode where power flows from the first switching circuit to the second switching circuit, and a second operation mode where power flows from the second switching circuit to the first switching circuit, wherein the switching method includes: during the transition of the resonant converter from the first operation mode to the second operation mode, controlling the phase of the current flowing into the resonant network to remain unchanged.

### CROSS-REFERENCE TO RELATED APPLICATIONS

This non-provisional application claims priorities under 35 U.S.C. § 119(a) on Patent Application 202510156818.0 filed in P.R. China on Feb. 12, 2025 and Application 202511286984.9 filed in P.R. China on Sep. 9, 2025, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### BACKGROUND OF THE INVENTION

### 1. Field of the Invention

The present disclosure relates to the field of power electronics technology, and in particular, to a resonant converter, a method for switching thereof and a distributed power supply system.

### 2. Related Art

As currently popular DC-DC topology, LLC has broad application prospects in fields such as, microgrid, data center, energy storage, electric vehicle, and the like. How to achieve bidirectional operation capability of the LLC circuit, improve bidirectional operation capability in a wide range, further achieving seamless forward and reverse switching and improving dynamic performance has great significance.

As shown in FIG. 1, the LLC topological structure includes a first switching circuit C1, a resonant network C3 and a second switching circuit C2 connected sequentially, the first switching circuit C1 includes switches Q₁, Q₂, a first port and a second port, and the second switching circuit C2 includes switches S₁, S₂, a third port and a fourth port, the resonant network C3 is connected between the second port and the third port, a voltage of the first port of the first switching circuit C1 is V₁, a voltage across the fourth port of the second switching circuit C2 is V₂, the resonant network C3 includes a transformer T, a resonant inductor Lᵣ and a resonant capacitor Cᵣ, a turns ratio of a primary winding and a secondary winding of the transformer T is n, Iₛ is a current flowing through the primary winding of the transformer, I_{Lr} is a current of the resonant inductor, and I_{Lm} is a current of the magnetizing inductor.

Currently, there have been relevant methods to achieve bidirectional operation for LLC converters: when a gain is equal to 1 (nV₂/V₁=1), during forward operation, the primary side works at a resonant frequency, and the secondary side follows the primary side with synchronous rectification; during reverse operation, the secondary side works at the resonant frequency, and the primary side follows the secondary side with synchronous rectification. When the gain is greater than 1 (nV₂/V₁>1), during forward operation, a working frequency of the primary side is less than the resonant frequency, and the secondary side follows the primary side with synchronous rectification; during reverse direction, the working frequency of the secondary side is greater than the resonant frequency, and the primary side follows the secondary side with synchronous rectification. When the gain is less than 1 (nV₂/V₁<1), reverse operation cannot be achieved with frequency modulation control, and specific reasons are shown in FIG. 2 (Q represents a quality factor, the larger Q is, the heavier the load will be, fs represents a working frequency, and fr represents a resonant frequency). During reverse operation, the gain is always less than 1, making reverse voltage step-up unattainable. As shown in FIGS. 1 and 3, in the forward and reverse switching process, it is necessary to stop operation to switch control logic. During this shutdown period, there is no power transmission, failing to achieve seamless bidirectional switching. In the restarting process, the current I_{Lr} of the resonant inductor will oscillate.

With reference to the circuit topology shown in FIG. 4A, the prior art 1 is a DCX method, including: during forward operation, the primary side works at a resonant frequency, and the secondary side operates synchronously with the primary side; during reverse operation, the secondary side works at the resonant frequency, and the primary side operates synchronously with the secondary side. The method may enable seamless power between forward and reverse operation modes. However, the method is only applicable to the present disclosure where the gain is 1, and in the switching process, the system temporarily oscillates.

The prior art 2 uses a circuit topology of LLCL shown in FIG. 4B, and an inductor L in symmetrical with an magnetizing inductor of the transformer is connected to a second port. During forward operation, the primary side performs frequency modulation, and the secondary side performs synchronous rectification; during reverse operation, the secondary side performs frequency modulation, and the primary side performs synchronous rectification. The method achieves a gain less than 1 during reverse operation, and enables switching between forward and reverse operation modes. However, the addition of the symmetric magnetizing inductor increases both cost and volume of the system, and transient oscillations occur in the switching process.

As shown in FIG. 5, directly implementing seamless bidirectional switching in LLC circuit remains problematic. Since phases between a current of the resonant tank and a port voltage in forward and reverse operations are different, directly switching the resonant tank will cause current phase reversal, leading to distortion and oscillation in the resonant tank, and may further lead to overcurrent issues. The main reason is that LLC may be equivalent to an equivalent voltage source V_{1_eq} and an equivalent inductor L_{r_eq}, as shown in FIG. 6. The system is a second-order system, and a transfer function of an output current Iₒ and a resonant tank current I_{Lr_eq} is shown in formula (1):

$$\frac{{I}_{Lr \_ eq} ( s )}{{I}_{o} ( s )} = \frac{{C}_{o} s}{{L}_{r \_ eq} {C}_{o} {s}^{2} + 1} , \qquad formula ( 1 )$$

When the output current Iₒ suddenly changes, i.e., a step response occurs, it causes oscillation and distortion in the resonant tank current. Till now, there is no existing technology that enables seamless switching for LLC converters while mitigating current oscillation under various working conditions.

### SUMMARY OF THE INVENTION

An object of the present disclosure is to provide a method for switching bidirectional operation of a resonant converter, a resonant converter and a distributed power supply system capable of solving one or more deficiencies in the prior art.

In order to achieve the above object, the present disclosure provides a method for switching bidirectional operation of a resonant converter, the resonant converter including a first switching circuit, a resonant network and a second switching circuit connected sequentially, the first switching circuit including a first port and a second port, the second switching circuit including a third port and a fourth port, the resonant network connected between the second port and the third port, the bidirectional operation including a first operation mode where power flows from the first switching circuit to the second switching circuit, and a second operation mode where power flows from the second switching circuit to the first switching circuit, wherein the switching method includes:
during the transition of the resonant converter from the first operation mode to the second operation mode, controlling the phase of the current flowing into the resonant network to remain unchanged.

The present disclosure further provides a resonant converter, including: a first switching circuit including a first port and a second port; a second switching circuit including a third port and a fourth port; a resonant network connected between the second port and the third port, the resonant converter operating in a first operation mode where power flows from the first switching circuit to the second switching circuit, or a second operation mode where power flows from the second switching circuit to the first switching circuit; and a controller for controlling switching between the first operation mode and the second operation mode, during the transition of the resonant converter from the first operation mode to the second operation mode, the phase of the current flowing into the resonant network is controlled to remain unchanged.

The present disclosure further provides a distributed power supply system, including a plurality of power supply units and a controller, wherein each of the power supply units includes a plurality of cascaded power supply modules, each including a first resonant converter and a second resonant converter connected in parallel, each of the first resonant converter and the second resonant converter includes a first switching circuit, a resonant network and a second switching circuit connected sequentially, the first switching circuit includes a first port and a second port, the second switching circuit includes a third port and a fourth port, the resonant network is connected between the second port and the third port, power flows from the first switching circuit to the second switching circuit in a first operation mode, and power flows from the second switching circuit to the first switching circuit in a second operation mode,
the controller is configured to control switching between the first operation mode and the second operation mode, during the transition of the resonant converter from the first operation mode to the second operation mode, the phase of the current flowing into the resonant network is controlled to remain unchanged.

The present disclosure further provides a method for switching bidirectional operation of a resonant converter, the resonant converter including a first switching circuit, a resonant network and a second switching circuit connected sequentially, the first switching circuit including a first port and a second port, the second switching circuit including a third port and a fourth port, the resonant network connected between the second port and the third port, the bidirectional operation including a first operation mode where power flows from the first switching circuit to the second switching circuit, and a second operation mode where power flows from the second switching circuit to the first switching circuit, the resonant converter including a transformer, and a turns ratio of a primary winding and a secondary winding of the transformer being n, wherein when a voltage of the first port is greater than n multiplied by a voltage of the fourth port, the switching method includes: in the first operation mode, controlling the first switching circuit and the second switching circuit to operate synchronously; and in the second operation mode, controlling the first switching circuit to operate with a phase shift relative to the second switching circuit.

The method for switching bidirectional operation provided in the present disclosure is applied to a bidirectional operating resonant converter, and in the present disclosure that the gain of the resonant converter is equal to 1, the gain is greater than 1 and the gain is less than 1, phase inversion of a port voltage of the resonant tank is achieved, thereby rapidly and seamlessly switching between forward and reverse operations, reducing oscillation of the resonant converter, and preventing overcurrent.

The method for switching bidirectional operation further provided in the present disclosure is applied to a bidirectional operating resonant converter, and when the gain of the resonant converter is less than 1, phase inversion of a port current of the resonant tank is achieved, thereby rapidly and seamlessly switching between forward and reverse operations, and achieving a no-bias current.

Each power supply module of the distributed power supply system provided in the present disclosure includes a resonant converter having different operation modes, such that power scheduling of the distributed power supply system is more flexible, and reliability of the system is improved.

### BRIEF DESCRIPTION OF THE DRAWINGS

To clearly explain the technical solution carried out in the present disclosure, hereinafter the accompanying drawings to be used in the embodiments are simply introduced.

FIG. 1 is a schematic diagram of a topology of a LLC circuit in the prior art;

FIG. 2 is a schematic diagram of gains when the LLC circuit shown in FIG. 1 operates forward and reverse;

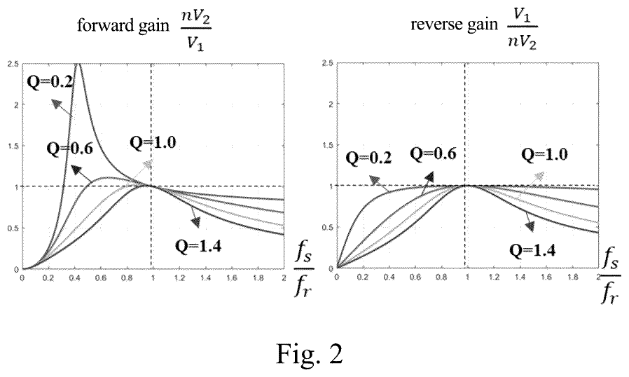

FIG. 3 is a schematic diagram of switching when the LLC circuit in the prior art operates forward and reverse;

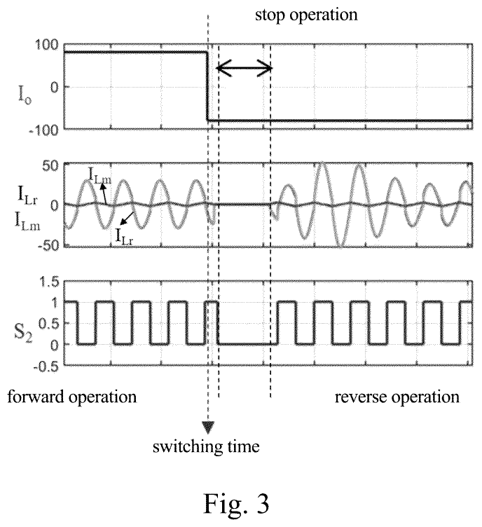

FIG. 4A is a topological diagram of a DCX method in the prior art 1;

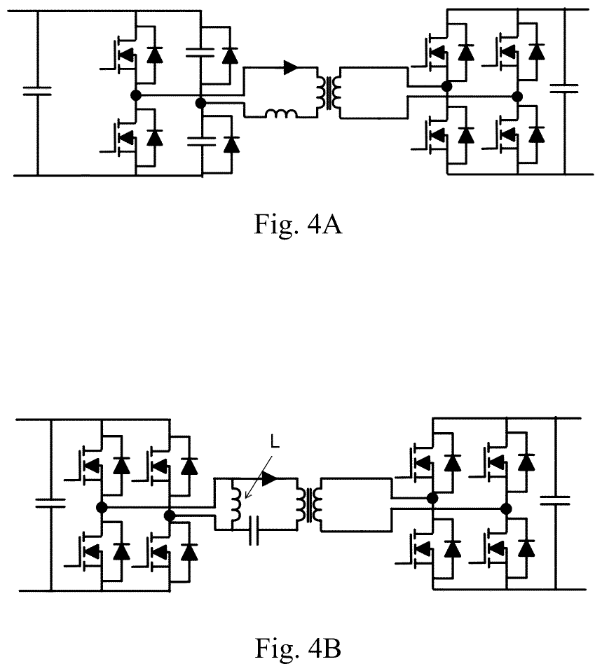

FIG. 4B is a topological diagram of a LLCX circuit in the prior art 2;

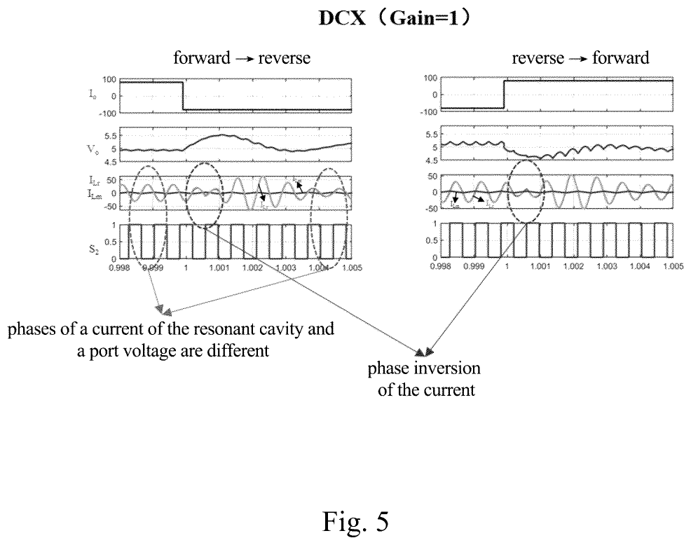

FIG. 5 is a schematic diagram of phase inversion of a current seamlessly switched by the LLC in the prior art;

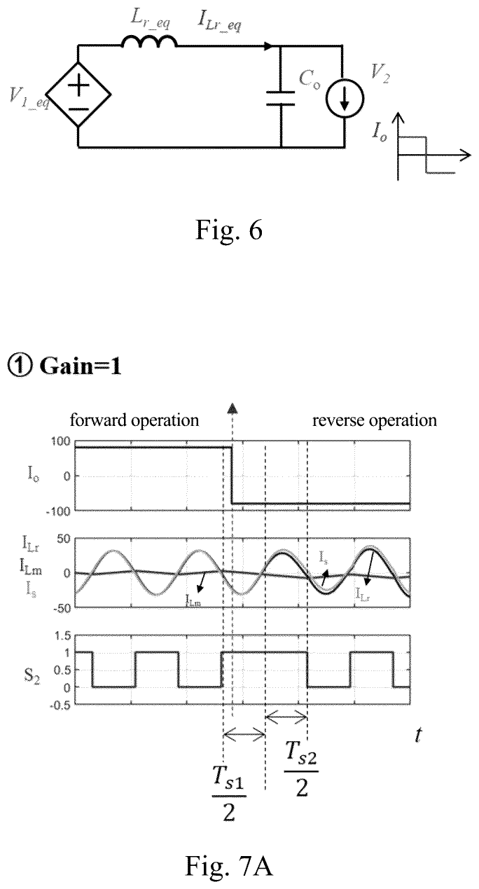

FIG. 6 is a diagram of an equivalent circuit of the LLC in the prior art;

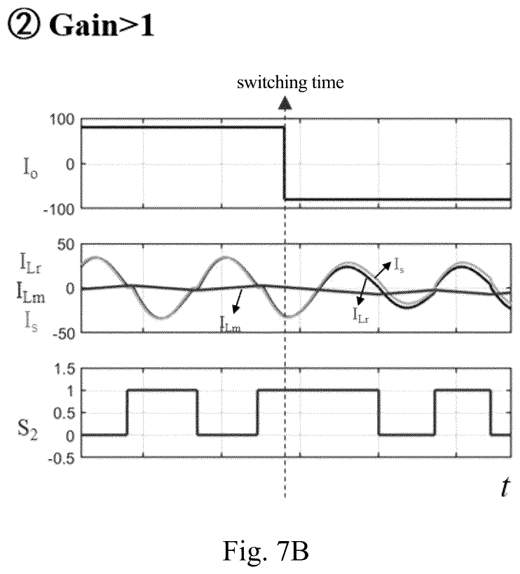

FIGS. 7A-7C are schematic diagrams of a method for switching bidirectional operation in a first embodiment of the present disclosure;

FIG. 8 is a schematic diagram of different time periods during switching of bidirectional operation when a gain is equal to 1;

FIG. 9 is a schematic diagram of state trajectory of a resonant network at different time periods;

FIG. 10 is a comparison diagram of operation results of the present disclosure and the prior art;

FIG. 11 is a schematic diagram where the process of switching bidirectional operation of the present disclosure includes a dead zone;

FIG. 12 is a schematic diagram where a switching time T is prolonged and shortened in the process of switching bidirectional operation of the present disclosure;

FIG. 13 is a relation diagram between an oscillation amplitude and a switching time of the resonant network;

FIG. 14 is a schematic diagram of a bias produced by an magnetizing current;

FIG. 15 is a schematic diagram where the bias of the magnetizing current is eliminated;

FIG. 16 is a structural diagram of a circuit of a resonant converter;

FIG. 17 is a structural diagram of another circuit of a resonant converter;

FIGS. 18A-18C show waveforms of the second port voltage and the third port voltage for different embodiments where the switching command is received when the second port voltage is at a low level;

FIGS. 19A-19C show waveforms of the second port voltage and the third port voltage for different embodiments where the switching command is received when the second port voltage is at a high level;

FIG. 20 is a schematic diagram of a method for switching bidirectional operation in a second embodiment of the present disclosure;

FIG. 21A is a structural diagram of a distributed power supply system;

FIG. 21B is a structural diagram of power supply modules.

### DETAILED EMBODIMENTS OF THE INVENTION

The exemplary embodiments will now be described more fully with reference to the accompanying drawings. The exemplary embodiments can, however, be implemented in various forms, and should not be construed as being limited to the embodiments set forth herein; rather, these embodiments are provided so that the present disclosure will be thorough and complete, and will fully convey the concept of the exemplary embodiments to those skilled in the art.

When introducing elements or constituting parts or the like described and/or illustrated here, the terms “one”, “a(an)”, “the”, “said” and “at least one” represent one or more elements or constituting parts or the like. Terms “include”, “comprise” and “have” represent an open and inclusive meaning, and also refer to additional elements or constituting parts or the like in addition to the listed elements or constituting parts or the like. Moreover, the terms “first”, “second” and the like in the claims are only used as reference signs, rather limiting the number of the objects. In the drawings, the same reference numerals denote the same or similar component. On the other hand, the commonly known components and steps are not described in the embodiments to avoid causing unnecessary limit to the present disclosure. Moreover, in order to simplify the accompanying drawings, some known customary structures and elements are drawn in the accompanying drawings in a simple illustrative manner.

The first embodiment of the present disclosure provides a method for switching bidirectional operation of a resonant converter, wherein the resonant converter includes a first switching circuit, a resonant network and a second switching circuit connected sequentially, the first switching circuit includes a first port and a second port, the second switching circuit includes a third port and a fourth port, the resonant network is connected between the second port and the third port, the bidirectional operation includes a first operation mode where power flows from the first switching circuit to the second switching circuit, and a second operation mode where power flows from the second switching circuit to the first switching circuit, and the switching method includes:
during the transition of the resonant converter from the first operation mode to the second operation mode, controlling the phase of the current flowing into the resonant network to remain unchanged.

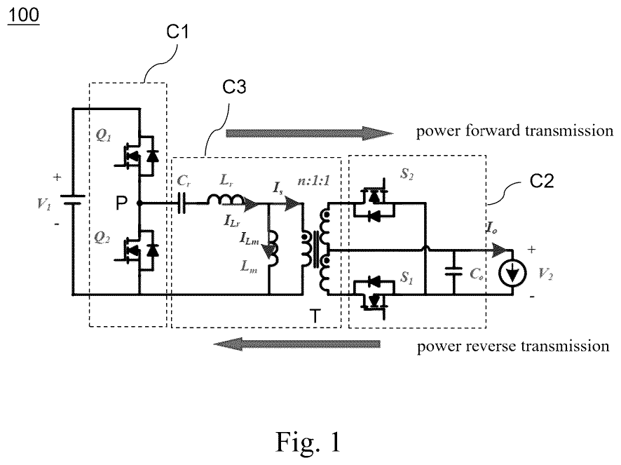

The method for switching bidirectional operation of the present disclosure can be applied, for example, to a resonant converter shown in FIG. 1. As shown in FIG. 1, the resonant converter 100 includes a first switching circuit C1, a resonant network C3 and a second switching circuit C2 connected sequentially. The first switching circuit C1 includes switches Q₁ and Q₂ connected in series. A first port is formed between a first terminal of the switch Q₁ and a second terminal of the switch Q₂, a voltage across the first port is V₁, and a second terminal of the switch Q₁ and a first terminal of the switch Q₂ are together connected to a connection point P. A second port is formed between the connection point P and the second terminal of the switch Q₂. The second switching circuit C2 is a full-wave rectifying circuit including switches S₁ and S₂. The second switching circuit C2 includes a third port and a fourth port, and a voltage across the fourth port is V₂. The resonant network C3 includes a transformer T, a resonant inductor Lᵣ and a resonant capacitor Cᵣ, a turns ratio of a primary winding and a secondary winding of the transformer T is n, and the resonant network C3 is connected between the second port and the third port. The transformer is a center-tapped transformer. The resonant converter 100 operates in a first operation mode or a second operation mode, and the resonant converter 100 further includes a controller (not shown) for controlling switching between the first operation mode and the second operation mode:
during the transition of the resonant converter from the first operation mode to the second operation mode, the phase of the current flowing into the resonant network is controlled to remain unchanged.

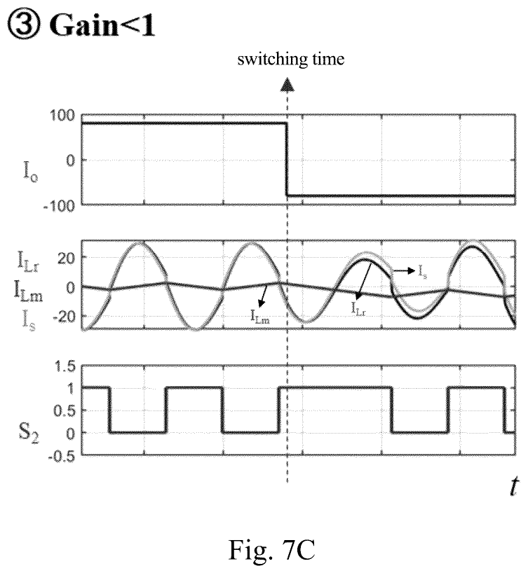

FIG. 7A is a schematic diagram of a method for switching bidirectional operation in a first embodiment of the present disclosure. Combining FIGS. 1 and 7A, Iₒ is an output current of the resonant converter 100, I_{Lr} is a current flowing through the resonant inductor in the resonant network C3, I_{Lm} is a current flowing through the magnetizing inductor in the resonant network C3, and Iₛ is a current flowing through a primary winding of the transformer. When a voltage of the first port is equal to n multiplied by a voltage of the fourth port, i.e., when a gain is equal to 1, and the resonant converter 100 works in the first operation mode (for example, forward operation, power flows from the first switching circuit C1 to the second switching circuit C2), the first switching circuit C1 works at a resonant frequency, and the second switching circuit C2 operates synchronously with the first switching circuit C1. When the resonant converter 100 works in the second operation mode (for example, reverse operation, power flows from the second switching circuit C2 to the first switching circuit C1), the second switching circuit C2 works at the resonant frequency, and the first switching circuit C1 operates synchronously with the second switching circuit C2. Referring to FIG. 7A, during the switching interval that includes the moment of transition between the forward and reverse operation modes, the switching instants of the switches in the current first switching circuit C1 and second switching circuit C2 (FIG. 7A shows a drive waveform for the switch S₂, a drive waveform for the switch Q₂ is the same as that of the switch S₂, but not shown) are delayed by T_{S2}/2, wherein T_{S1} is a working period of the first working circuit before the mode switching, and T_{S2} is a working period of the second working circuit after the mode switching. Phase inversion of a port voltage is achieved (the port voltage and the current of the resonant tank are in reverse phase), and a current Is flowing through the primary winding of the transformer will not have obvious oscillation.

In the method for switching bidirectional operation in the first embodiment of the present disclosure, in the present disclosure that the gain of the resonant converter is equal to 1, the gain is greater than 1 and the gain is less than 1, phase inversion of the port voltage across the resonant tank may be achieved, thereby rapidly and seamlessly switching between forward and reverse operations, reducing oscillation of the resonant converter, and preventing overcurrent. With other gains, the method for switching bidirectional operation in the first embodiment of the present disclosure is still applicable.

When the voltage across the first port is less than n multiplied by the voltage of the fourth port, i.e., when the gain is greater than 1, and the resonant converter 100 works in the first operation mode, a working frequency of the first switching circuit C1 is less than the resonant frequency, and the second switching circuit C2 operates synchronously with the first switching circuit C1. When the resonant converter 100 works in the second operation mode, a working frequency of the second switching circuit C2 is greater than the resonant frequency, and the first switching circuit C1 operates synchronously with the second switching circuit C2. As shown in FIG. 7B, during the switching interval that includes the moment of transition between the forward and reverse operation modes, the switching instants of the switches in the current first switching circuit and second switching circuit are delayed by T_{S2}/2. Phase inversion of a port voltage is achieved (the port voltage and the current of the resonant tank are in reverse phase), and the current Iₛ flowing through the primary winding of the transformer will not have obvious oscillation.

When the voltage of the first port is greater than n multiplied by the voltage of the fourth port, i.e., when the gain is less than 1, and the resonant converter 100 works in the first operation mode, the working frequency of the first switching circuit C1 is greater than the resonant frequency, and the second switching circuit C2 operates synchronously with the first switching circuit C1. When the resonant converter 100 works in the second operation mode, the working frequency of the second switching circuit C2 is greater than the resonant frequency, and the first switching circuit C1 operates synchronously with the second switching circuit C2. As shown in FIG. 7C, during the switching interval that includes the moment of transition between the forward and reverse operation modes, the switching instants of switches in the current first switching circuit and second switching circuit are delayed by T_{S2}/2. Phase inversion of a port voltage is achieved (the port voltage and the resonant tank current are in reverse phase), and the current Iₛ flowing through the primary winding of the transformer will not have obvious oscillation.

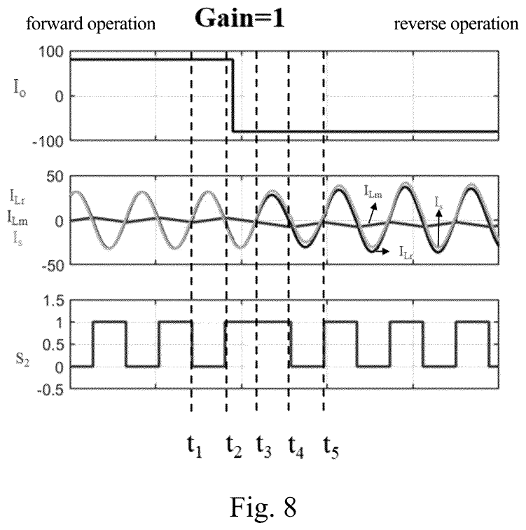

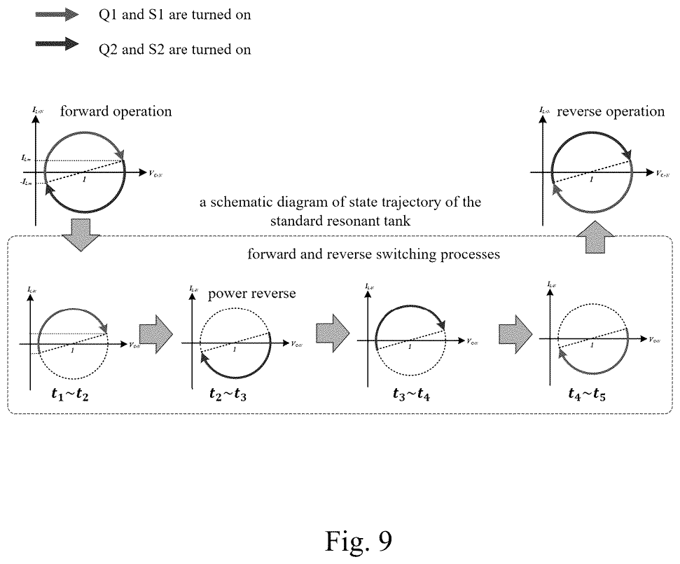

Further, the process of bidirectional operation switching of the present disclosure may be divided into several processes, as shown in FIG. 8. t₁ to t₅ includes several time periods of the switching process. The state trajectory of the corresponding normalized resonant tank current I_{LrN} and normalized resonant tank voltage V_{CrN} is shown in FIG. 9. Combining with FIGS. 1A and 8-9, in the time period t₁ to t₂, the resonant converter 100 operates forward, and the switch Q₁ in the first switching circuit C1 and the switch S₁ in the second switching circuit C2 are turned on; in the time period t₂ to t₃, the switch Q₂ in the first switching circuit C1 and the switch S₂ in the second switching circuit C2 are turned on, and the resonant converter 100 is switched between forward operation and reverse operation in this time period; in the time period t₃ to t₄, the switches Q₂ and S₂ are continued to be turned on, and in the state trajectory, since trajectory state points of the switches Q₁ and Q₂ are close to each other, continuing to turn on the switches Q₂ and S₂ in this time period does not affect a trajectory circle center, i.e., the trajectory continues to evolve in a circle; in the time period t₄ to t₅, the switches Q₁ and S₁ are turned on, and the resonant converter 100 completes switching of bidirectional operation. As can be seen from the state trajectory, in the method for switching bidirectional operation, the forward and reverse operations are switched at a position of adjacent modal points, such that the switching process is smooth.

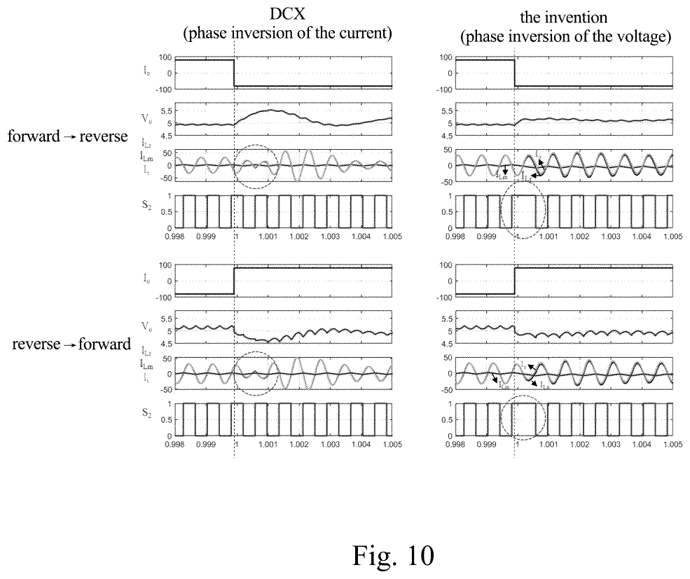

As shown in FIG. 10, in the DCX method of the prior art, since phases between a current of the resonant tank and a port voltage in forward and reverse operations are different, directly switching the resonant tank will result in phase inversion of the current, leading to current distortion and current oscillation of the resonant tank, and may further cause the overcurrent issue. The present disclosure provides a voltage phase inversion method, which achieves smooth transition during forward-to-reverse switching of the LLC circuit by changing the phase of the port voltage across the resonant tank while not changing the phase of the current. Compared to the current phase reversal method in the prior art, the method for switching bidirectional operation in the present disclosure largely reduces the issue of current oscillation of the resonant tank and the overcurrent issue.

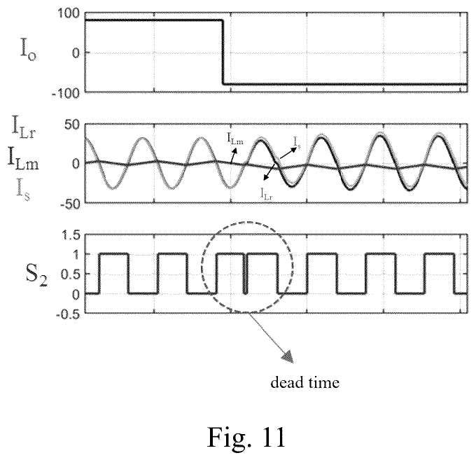

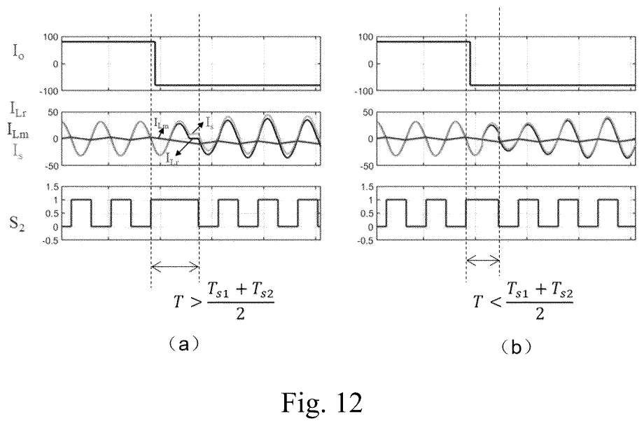

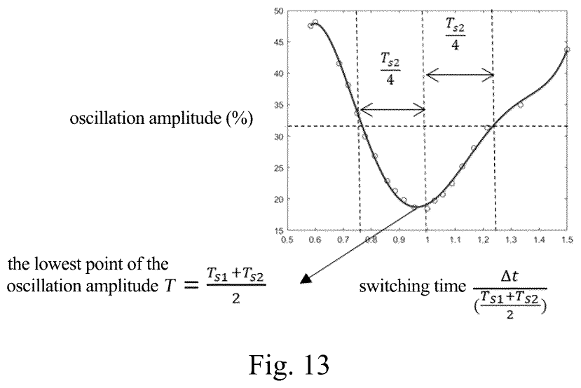

In actual application, due to issues of driving requirements, influence of controlling or measuring accuracy, the process of bidirectional operation switching may include a dead time (as shown in FIG. 11), a fine-tune switching time (as shown in FIG. 12) and the like, and influence on system oscillation is small. When adjusting the switching time, T=(T_{S1}+T_{S2})/2 is the optimal switching time. As shown in FIGS. 12(a) and (b), the switching time T of the switching interval has an adjustment range, T may be slightly greater than (T_{S1}+T_{S2})/2 or slightly less than (T_{S1}+T_{S2})/2, T_{S1} is a working period of the first working circuit before switching of the operation mode, T_{S2} is a working period of the second working circuit after switching of the operation mode. According to simulation results shown in FIG. 13, within a range of the switching time Tϵ[(T_{S1}+T_{S2})/2−T_{S2}/4, (T_{S1}+T_{S2})/2+T_{S2}/4], an oscillation amplitude of the resonant tank may be reduced by about 50% relative to the prior art (current phase reversal). Therefore, preferably, the method for switching bidirectional operation includes: during the transition of the resonant converter from the first operation mode to the second operation mode, control a duration T to satisfy the following inequality:

$$( T 1 + T 2 ) / 2 - Δ T ⩽ T ⩽ ( T 1 + T 2 ) / 2 + Δ T ,$$

wherein, T1 is a switching period where the first switching circuit works in the first operation mode, T2 is a switching period where the second switching circuit works in the second operation mode, the duration T is the total time from the start of the voltage level present across the second port at the moment when the mode-switching command is received to the start of the first opposite voltage level that subsequently appears across the second port after the command, and ΔT is T2/4. Here, the opposite voltage level refers to a level that is equal in magnitude but opposite in polarity. For example, the opposite voltage level of the high voltage level is the low voltage level, and the opposite voltage level of the low voltage level is the high level.

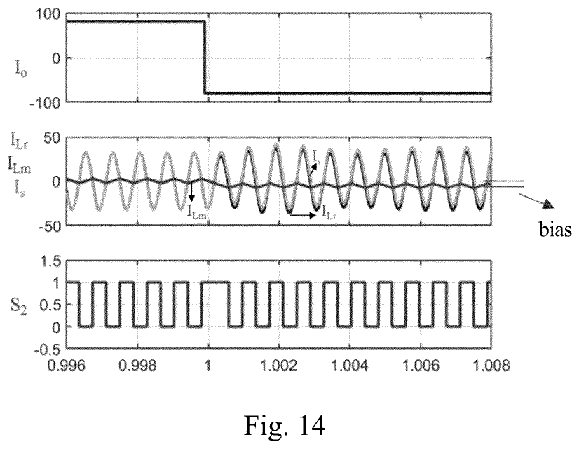

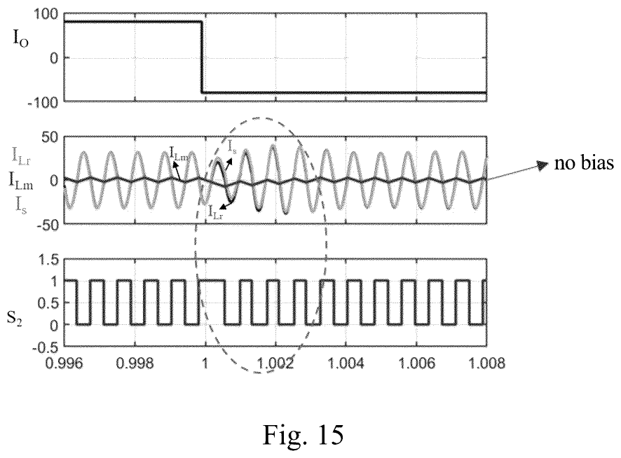

As shown in FIG. 14, the method for switching bidirectional operation in the first embodiment of the present disclosure is applied to the resonant converter 100, and a bias phenomenon may occur in the current I_{Lm} of the magnetizing inductor, so variation of an magnetizing current may be controlled using a close-loop control to rapidly eliminate the bias issue brought by seamless switching. For example, a duty ratio regulated value is obtained according to a current detection value and a reference value of the magnetizing inductor of the resonant network C3, and duty ratios of switches in the first switching circuit C1 and the second switching circuit C2 are regulated according to the duty ratio regulated value, thereby suppressing the current bias of the magnetizing inductor. Regulation results are shown in FIG. 15, and bias of the current I_{Lm} of the magnetizing inductor is suppressed.

The present disclosure further provides a resonant converter, including: a first switching circuit, a resonant network, a second switching circuit connected sequentially and a controller. The first switching circuit includes a first port and a second port, the second switching circuit includes a third port and a fourth port, the resonant network is connected between the second port and the third port, the resonant converter operates in a first operation mode where power flows from the first switching circuit to the second switching circuit, or a second operation mode where power flows from the second switching circuit to the first switching circuit, and the controller is configured to control switching between the first operation mode and the second operation mode:
during the transition of the resonant converter from the first operation mode to the second operation mode, the phase of the current flowing into the resonant network is controlled to remain unchanged.

The resonant network includes an magnetizing inductor, the controller outputs a driving signal to a switch of the first switching circuit and a switch of the second switching circuit according to a current detection value and a reference value of the magnetizing inductor, so as to regulate duty ratios of switches in the first switching circuit and the second switching circuit, thereby suppressing a current bias of the magnetizing inductor.

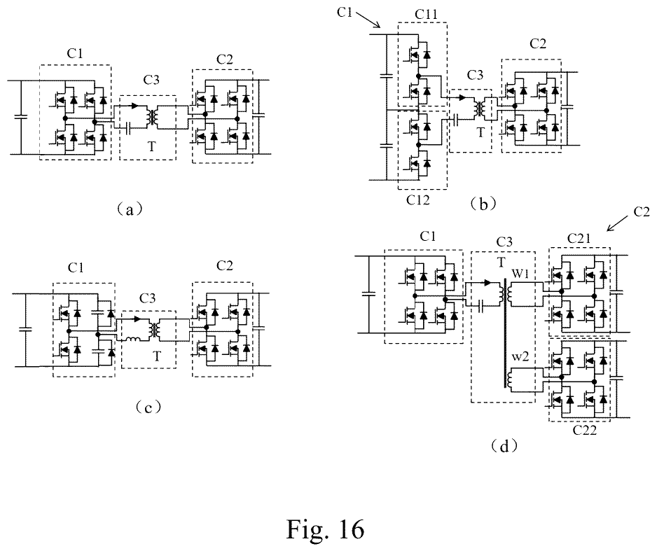

The first switching circuit, the second switching circuit and the resonant network of the resonant converter may have different topological structures, and the topological structure of the resonant converter is, for example, a topological structure of the circuit of the resonant converter 100 shown in FIG. 1, and also may be other bidirectional operating topological structures, as shown in FIGS. 16 (a) to (d).

Referring to FIG. 16(a), the resonant converter includes a first switching circuit C1, a resonant network C3 and a second switching circuit C2 connected sequentially, the first switching circuit C1 includes a first port and a second port, the second switching circuit C2 includes a third port and a fourth port, the resonant network C3 is connected between the second port and the third port, the first switching circuit C1 is a full-bridge inverter circuit, the resonant network C3 includes a transformer T, the second switching circuit C2 includes a full-bridge rectifying circuit, and the third port of the second switching circuit C2 is connected to a secondary winding of the transformer T.

Referring to FIG. 16(b), the resonant converter includes a first switching circuit C1, a resonant network C3 and a second switching circuit C2 connected sequentially, the first switching circuit C1 includes a first port and a second port, the second switching circuit C2 includes a third port and a fourth port, the resonant network C3 is connected between the second port and the third port, the first switching circuit C1 includes a first half-bridge circuit C11 and a second half-bridge circuit C12 connected in series, the second port is formed between a middle point of the first half-bridge circuit C11 and a middle point of the second half-bridge circuit C12, the resonant network C3 includes a transformer T, the second switching circuit C2 is a full-bridge rectifying circuit, and the third port of the second switching circuit C2 is connected to a secondary winding of the transformer T.

Referring to FIG. 16(c), the resonant converter includes a first switching circuit C1, a resonant network C3 and a second switching circuit C2 connected sequentially, the first switching circuit C1 includes a first port and a second port, the second switching circuit C2 includes a third port and a fourth port, the resonant network C3 is connected between the second port and the third port, the first switching circuit C1 includes a first branch and a second branch connected in parallel, the first branch includes a first switch and a second switch connected in series, the second branch includes a first capacitor and a second capacitor connected in series, the first capacitor and the second capacitor are connected in parallel to a diode, respectively, the resonant network C3 includes a transformer T, the second switching circuit C2 is a full-bridge rectifying circuit, and the third port of the second switching circuit C2 is connected to a secondary winding of the transformer T.

Referring to FIG. 16(d), the resonant converter includes a first switching circuit C1, a resonant network C3 and a second switching circuit C2 connected sequentially, the first switching circuit C1 includes a first port and a second port, the second switching circuit C2 includes a third port and a fourth port, the resonant network C3 is connected between the second port and the third port, the first switching circuit C1 is a full-bridge inverter circuit, the resonant network C3 includes a transformer T, and the second switching circuit C2 includes a first secondary full-bridge circuit C21 connected to a first secondary winding W1 of the transformer T, and a second secondary full-bridge circuit C22 connected to a second secondary winding W2 of the transformer T.

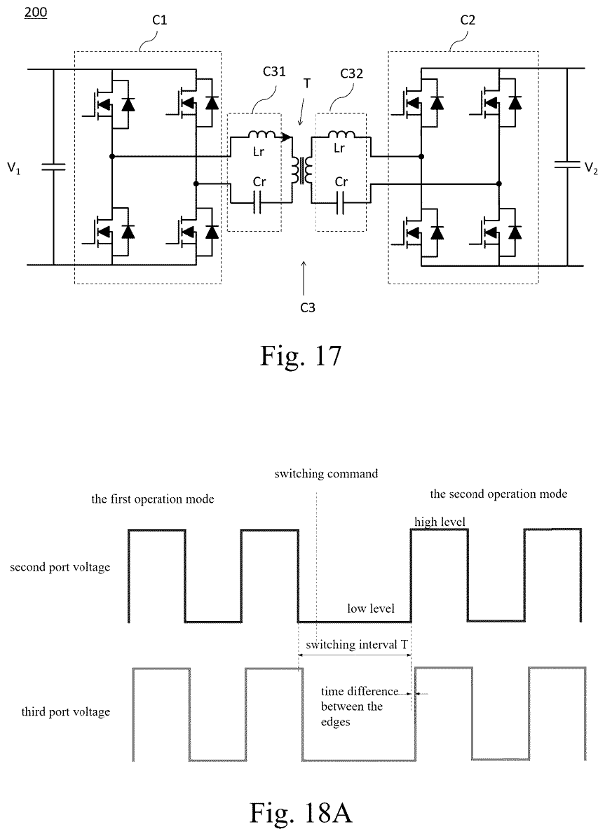

FIG. 17 is a schematic diagram of another circuit structure of the resonant converter. As shown in FIG. 17, the resonant converter 200 is a CLLC circuit, which includes a first switching circuit C1, a resonant network C3, and a second switching circuit C2 connected sequentially. The first switching circuit C1 is a full-bridge inverter circuit, including a first bridge arm and a second bridge arm connected in parallel. The first switching circuit C1 includes a first port and a second port. The first and second terminals of the first bridge arm are connected to the two terminals of the first port, respectively, and the first and second terminals of the second bridge arm are also connected to the two terminals of the first port. The voltage across the first port is V₁. The midpoint of the first bridge arm and the midpoint of the second bridge arm are connected to the two terminals of the second port, respectively. The second switching circuit C2 is a full-bridge rectifier circuit, including a third bridge arm and a fourth bridge arm connected in parallel. The second switching circuit C2 includes a third port and a fourth port. The midpoint of the third bridge arm and the midpoint of the fourth bridge arm are connected to the two terminals of the third port, respectively. The first and second terminals of the third bridge arm are connected to the two terminals of the fourth port, and the first and second terminals of the fourth bridge arm are also connected to the two terminals of the fourth port. The voltage across the fourth port is V₂. The resonant network C3 is connected between the second port and the third port and includes a primary-side resonant network C31, a transformer T, and a secondary-side resonant network C32 connected sequentially. Both the primary-side resonant network C31 and the secondary-side resonant network C32 include a resonant inductor Lr and a resonant capacitor Cr. The resonant converter 200 operates in either the first operation mode or the second operation mode. The resonant converter 200 also includes a controller (not shown), which is used to control the switching between the first operation mode and the second operation mode:
during the transition of the resonant converter from the first operation mode to the second operation mode, the phase of the current flowing into the resonant network is controlled to remain unchanged.

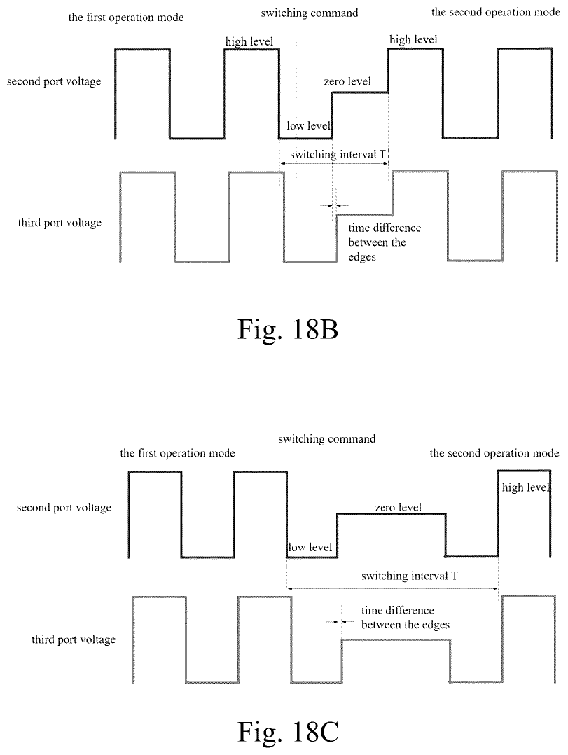

FIGS. 18A-18C show the waveforms of the second port voltage and the third port voltage for different embodiments where the switching command is received when the second port voltage is at a low level. The upper waveform in FIG. 18A is the voltage waveform of the second port of the resonant converter, and the lower waveform is the voltage waveform of the third port. As shown in FIG. 18A, during the switching interval between the first operation mode and the second operation mode, the second port voltage is maintained at a low level, and the time difference between the edges of the second port voltage and the third port voltage is less than T1/4, where T1 is the switching cycle when the first switching circuit C1 operates in the first operation mode.

The upper waveform in FIG. 18B is the voltage waveform of the second port of the resonant converter, and the lower waveform is the voltage waveform of the third port. As shown in FIG. 18B, during the switching interval between the first operation mode and the second operation mode, the second port voltage includes a low level and a zero level, and the time difference between the edges of the second port voltage and the third port voltage is less than T1/4, where T1 is the switching cycle when the first switching circuit C1 operates in the first operation mode.

The upper waveform in FIG. 18C is the voltage waveform of the second port of the resonant converter, and the lower waveform is the voltage waveform of the third port. As shown in FIG. 18C, during the switching interval between the first operation mode and the second operation mode, the second port voltage includes a low level and a zero level, and the time difference between the edges of the second port voltage and the third port voltage is less than T1/4, where T1 is the switching cycle when the first switching circuit C1 operates in the first operation mode. The difference from FIG. 18B is that in FIG. 18C, the switching interval includes one zero-level segment and two low-level segments of the second port voltage, with the zero-level segment located between the two low-level segments. In contrast, in FIG. 18B, the switching interval includes one zero-level segment and one low-level segment of the second port voltage.

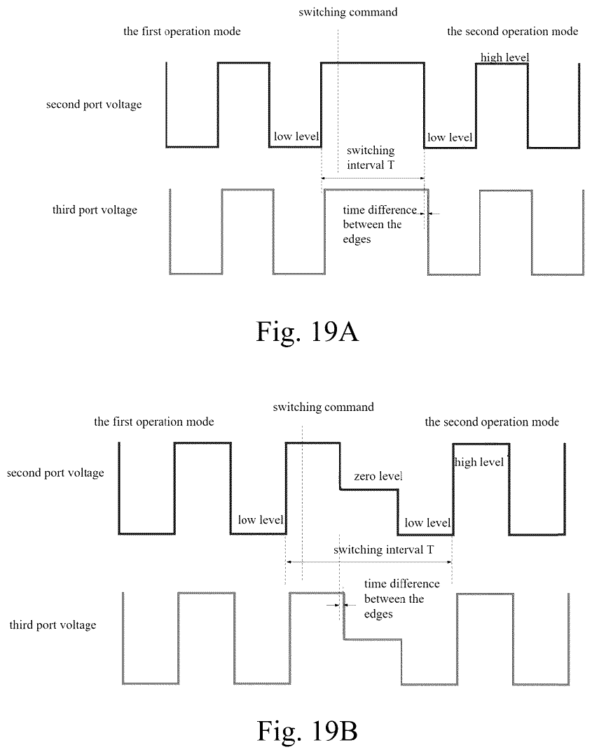

FIGS. 19A-19C show the waveforms of the second port voltage and the third port voltage for different embodiments where the switching command is received when the second port voltage is at a high level. FIGS. 19A-19C are similar to FIGS. 18A-18C. The difference is that in FIGS. 18A-18C, the switching command is received when the second port voltage is at a low level, whereas in FIGS. 19A-19C, the switching command is received when the second port voltage is at a high level. For FIGS. 18A-18C, when the switching command is received, the second port voltage is at a low level. The start of the switching interval T is the beginning moment of this low level, and the end of the switching interval is the beginning moment of the first high level after the switching command. For FIGS. 19A-19C, when the switching command is received, the second port voltage is at a high level. The start of the switching interval T is the beginning moment of this high level, and the end of the switching interval is the beginning moment of the first low level after the switching command.

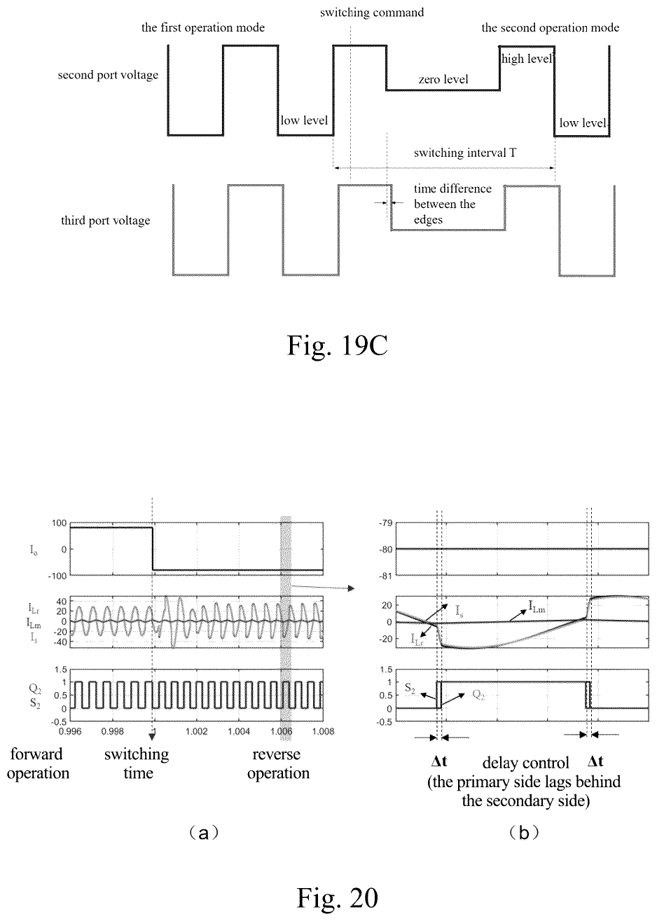

In FIG. 20, (a) is a schematic diagram of a method for switching bidirectional operation of a resonant converter in a second embodiment of the present disclosure, and (b) shows a control waveform of the resonant converter after switching the operation mode. The resonant converter includes a first switching circuit, a resonant network and a second switching circuit connected sequentially, the first switching circuit includes a first port and a second port, the second switching circuit includes a third port and a fourth port, the resonant network is connected between the second port and the third port, the bidirectional operation includes a first operation mode where power flows from the first switching circuit to the second switching circuit, and a second operation mode where power flows from the second switching circuit to the first switching circuit, the resonant converter includes a transformer, a turns ratio of a primary winding and a secondary winding of the transformer is n, and when a voltage of the first port is greater than n multiplied by a voltage of the fourth port, the switching method includes:
in the first operation mode, controlling the first switching circuit and the second switching circuit to operate synchronously; and
in the second operation mode, controlling the first switching circuit to operate with a phase shift relative to the second switching circuit.

The method for switching bidirectional operation in the second embodiment is applied to the resonant converter in the present disclosure that a gain is less than 1, in the first operation mode, a control signal received from the first switching circuit is the same as a switch control signal received from the second switching circuit, and switches in the first switching circuit and the second switching circuit operate synchronously. Referring to (b) in FIG. 20 and FIG. 1, in the second operation mode, the first switching circuit is controlled to operate with a phase shift relative to the second switching circuit, particularly including: controlling the first switching circuit ((b) in FIG. 20 shows a drive waveform of the switch Q₂) according to a first control signal, and controlling the second switching circuit ((b) in FIG. 20 shows a drive waveform of the switch S₂) according to a second control signal, wherein the first control signal is delayed with respect to the second control signal, and a delay time is, for example, Δt.

In other embodiments, in the first operation mode, the first switching circuit performs frequency modulation operation, and the second switching circuit operates synchronously with the first switching circuit; and in the second operation mode, the second switching circuit performs frequency modulation operation, and the first switching circuit operates lagging behind the second switching circuit.

Although the method for switching bidirectional operation shown in FIG. 20 causes oscillation and distortion issues in the current Is of the resonant tank, as compared to the method for switching bidirectional operation in the first embodiment of the present disclosure, an magnetizing current I_{Lm} has no bias. In actual application, the switching method may be selected according to actual issues.

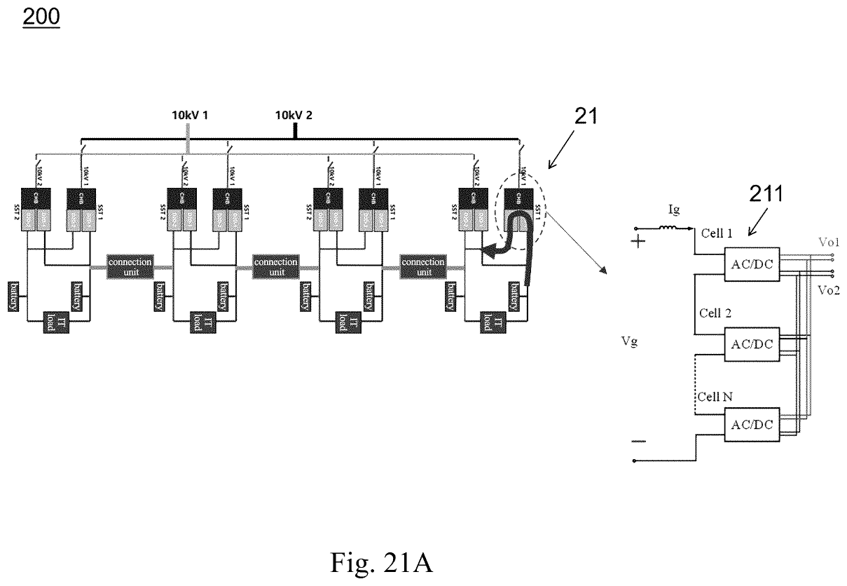

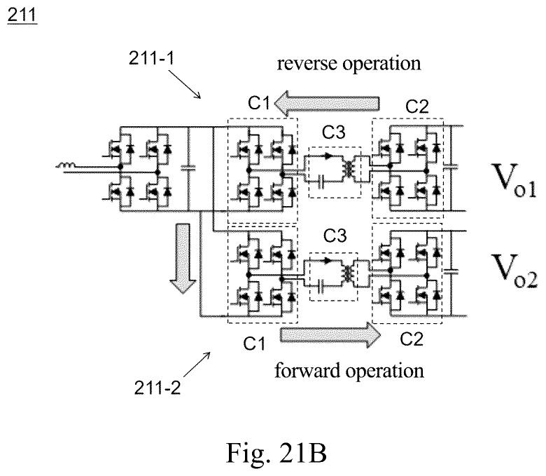

The present disclosure further provides a distributed power supply system. FIG. 21A is a structural diagram of a distributed power supply system, and FIG. 18B is a structural diagram of power supply modules in the distributed power supply system. As shown in FIG. 21A, a distributed power supply system 200 includes a plurality of power supply units 21 and a controller (not shown). Each of the power supply units 21 includes a plurality of cascaded power supply modules 211. As shown in FIG. 21B, each of the power supply modules 211 includes a first resonant converter 211-1 and a second resonant converter 211-2 connected in parallel, the first resonant converter 211-1 and the second resonant converter 211-2 respectively include a first switching circuit C1, a resonant network C3 and a second switching circuit C2 connected sequentially, the first switching circuit C1 includes a first port and a second port, the second switching circuit C2 includes a third port and a fourth port, the resonant network C3 is connected between the second port and the third port, power flows from the first switching circuit C1 to the second switching circuit C2 in the first operation mode, and power flows from the second switching circuit C2 to the first switching circuit C1 in the second operation mode,
during the transition of the resonant converter from the first operation mode to the second operation mode, the phase of the current flowing into the resonant network is controlled to remain unchanged.

Operation modes of the first resonant converter 211-1 and the second resonant converter 211-2 are completely independent of each other. That is, operation modes of the first resonant converter 211-1 and the second resonant converter 211-2 do not have mutual correlation, the operation mode of the first resonant converter 211-1 will not be affected by the operation mode of the second resonant converter 211-2, and vice versa.

In operation process of the distributed power supply system, the operation modes of the first resonant converter 211-1 and the second resonant converter 211-2 may be different, and when the first resonant converter 211-1 operates in the first operation mode, the second resonant converter 211-2 operates in the second operation mode, or when the first resonant converter 211-1 operates in the second operation mode, the second resonant converter 211-2 operates in the first operation mode. In such way, power scheduling of the power supply system is more flexible, and reliability is increased.

The method for switching bidirectional operation provided in the present disclosure is applied to the bidirectional operating resonant converter. Under conditions where the gain of the resonant converter is equal to 1, the gain is greater than 1 and the gain is less than 1, phase inversion of the port voltage of the resonant tank is achieved, thereby enabling rapidly and seamlessly switching between forward and reverse operations, reducing oscillation of the resonant converter, and preventing overcurrent.

The method for switching bidirectional operation provided in the present disclosure is applied to the bidirectional operating resonant converter, and when the gain of the resonant converter is less than 1, reversal of the port current of the resonant tank is achieved, thereby enabling rapidly and seamlessly switching between forward and reverse operations, and achieving a non-bias current.

Each power supply module of the distributed power supply system provided in the present disclosure includes the resonant converter having different operation modes, such that power scheduling of the distributed power supply system is more flexible, and reliability of the system is improved.

Although the embodiments of the present disclosure have been illustrated and described, it is appreciated that those ordinary in the art may make various changes, modifications, replacements and variations to these embodiments without departing from principle and spirit of the present disclosure, and the protection scope of the present disclosure is subjected to the scope defined by the appended claims.

What is claimed is:

1. A method for switching bidirectional operation of a resonant converter, the resonant converter comprising a first switching circuit, a resonant network and a second switching circuit connected sequentially, the first switching circuit comprising a first port and a second port, the second switching circuit comprising a third port and a fourth port, the resonant network connected between the second port and the third port, the bidirectional operation comprising a first operation mode where power flows from the first switching circuit to the second switching circuit, and a second operation mode where power flows from the second switching circuit to the first switching circuit, wherein the switching method comprises:
during the transition of the resonant converter from the first operation mode to the second operation mode, controlling the phase of the current flowing into the resonant network to remain unchanged.

2. The method for switching bidirectional operation of a resonant converter according to claim 1, during the transition of the resonant converter from the first operation mode to the second operation mode, control a duration T to satisfy the following inequality:
$$( T 1 + T 2 ) / 2 - Δ T ⩽ T ⩽ ( T 1 + T 2 ) / 2 + Δ T ,$$
wherein, T1 is a switching period where the first switching circuit works in the first operation mode, T2 is a switching period where the second switching circuit works in the second operation mode, the duration T is the total time from the start of the voltage level present across the second port at the moment when the mode-switching command is received to the start of the first opposite voltage level that subsequently appears across the second port after the command, and ΔT is T2/4.

3. The method for switching bidirectional operation of a resonant converter according to claim 1, wherein the resonant network comprises a transformer, and a turns ratio of a primary winding and a secondary winding of the transformer is n,
when a voltage of the first port is equal to n multiplied by a voltage of the fourth port, and the resonant converter works in the first operation mode, the first switching circuit works at a resonant frequency, and the second switching circuit operates synchronously with the first switching circuit; when the resonant converter works in the second operation mode, the second switching circuit works at the resonant frequency, and the first switching circuit operates synchronously with the second switching circuit;
when the voltage of the first port is less than n multiplied by the voltage of the fourth port, and the resonant converter works in the first operation mode, a working frequency of the first switching circuit is less than the resonant frequency, and the second switching circuit operates synchronously with the first switching circuit; when the resonant converter works in the second operation mode, a working frequency of the second switching circuit is greater than the resonant frequency, and the first switching circuit operates synchronously with the second switching circuit;
when the voltage of the first port is greater than n multiplied by the voltage of the fourth port, and the resonant converter works in the first operation mode, the working frequency of the first switching circuit is greater than the resonant frequency, and the second switching circuit operates synchronously with the first switching circuit; when the resonant converter works in the second operation mode, the working frequency of the second switching circuit is greater than the resonant frequency, and the first switching circuit operates synchronously with the second switching circuit.

4. The method for switching bidirectional operation of a resonant converter according to claim 1, wherein the resonant network comprises an magnetizing inductor, a duty ratio regulated value is obtained according to a current detection value and a reference value of the magnetizing inductor, and duty ratios of a switch of the first switching circuit and a switch of the second switching circuit are regulated according to the duty ratio regulated value, thereby suppressing a current bias of the magnetizing inductor.

5. A resonant converter, comprising:
a first switching circuit comprising a first port and a second port;
a second switching circuit comprising a third port and a fourth port;
a resonant network connected between the second port and the third port, the resonant converter operating in a first operation mode where power flows from the first switching circuit to the second switching circuit, or a second operation mode where power flows from the second switching circuit to the first switching circuit; and
a controller for controlling switching between the first operation mode and the second operation mode:
during the transition of the resonant converter from the first operation mode to the second operation mode, the phase of the current flowing into the resonant network is controlled to remain unchanged.

6. The resonant converter according to claim 5, during the transition of the resonant converter from the first operation mode to the second operation mode, control a duration T to satisfy the following inequality:
$$( T 1 + T 2 ) / 2 - Δ T ⩽ T ⩽ ( T 1 + T 2 ) / 2 + Δ T ,$$
wherein, T1 is a switching period where the first switching circuit works in the first operation mode, T2 is a switching period where the second switching circuit works in the second operation mode, the duration T is the total time from the start of the voltage level present across the second port at the moment when the mode-switching command is received to the start of the first opposite voltage level that subsequently appears across the second port after the command, and ΔT is T2/4.

7. The resonant converter according to claim 5, wherein the resonant network comprises an magnetizing inductor, and the controller outputs a driving signal to a switch of the first switching circuit and a switch of the second switching circuit according to a current detection value and a reference value of the magnetizing inductor, so as to regulate duty ratios of the switch of the first switching circuit and the switch of the second switching circuit, thereby suppressing a current bias of the magnetizing inductor.

8. The resonant converter according to claim 5, wherein the resonant network comprises a center-tapped transformer, the first switching circuit comprises a first switch and a second switch connected in series, the second switching circuit is a full-wave rectifying circuit, and the third port of the second switching circuit is connected to a secondary winding of the transformer.

9. The resonant converter according to claim 5, wherein the resonant network comprises a transformer, the first switching circuit is a full-bridge inverter circuit, the second switching circuit is a full-bridge rectifying circuit, and the third port of the second switching circuit is connected to a secondary winding of the transformer.

10. The resonant converter according to claim 5, wherein the resonant network comprises a transformer, the first switching circuit comprises a first half-bridge circuit and a second half-bridge circuit connected in series, the second switching circuit is a full-bridge rectifying circuit, and the third port of the second switching circuit is connected to a secondary winding of the transformer.

11. The resonant converter according to claim 5, wherein the resonant network comprises a transformer, the first switching circuit comprises a first branch and a second branch connected in parallel, the first branch comprises a first switch and a second switch connected in series, the second branch comprises a first capacitor and a second capacitor connected in series, the first capacitor and the second capacitor are connected in parallel to a diode, respectively, the second switching circuit is a full-bridge rectifying circuit, and the third port of the second switching circuit is connected to a secondary winding of the transformer.

12. The resonant converter according to claim 5, wherein the resonant network comprises a transformer, the first switching circuit is a full-bridge inverter circuit, and the second switching circuit comprises a first secondary full-bridge circuit connected to a first secondary winding of the transformer, and a second secondary full-bridge circuit connected to a second secondary winding of the transformer.

13. A distributed power supply system, comprising a plurality of power supply units and a controller, wherein each of the power supply units comprises a plurality of cascaded power supply modules, each comprising a first resonant converter and a second resonant converter connected in parallel, each of the first resonant converter and the second resonant converter comprises a first switching circuit, a resonant network and a second switching circuit connected sequentially, the first switching circuit comprises a first port and a second port, the second switching circuit comprises a third port and a fourth port, the resonant network is connected between the second port and the third port, power flows from the first switching circuit to the second switching circuit in a first operation mode, and power flows from the second switching circuit to the first switching circuit in a second operation mode,
the controller is configured to control switching between the first operation mode and the second operation mode, and during the transition of the resonant converter from the first operation mode to the second operation mode, the phase of the current flowing into the resonant network is controlled to remain unchanged.

14. The power supply system according to claim 13, during the transition of the resonant converter from the first operation mode to the second operation mode, control a duration T to satisfy the following inequality:
$$( T 1 + T 2 ) / 2 - Δ T ⩽ T ⩽ ( T 1 + T 2 ) / 2 + Δ T ,$$
wherein, T1 is a switching period where the first switching circuit works in the first operation mode, T2 is a switching period where the second switching circuit works in the second operation mode, the duration T is the total time from the start of the voltage level present across the second port at the moment when the mode-switching command is received to the start of the first opposite voltage level that subsequently appears across the second port after the command, and ΔT is T2/4.

15. The power supply system according to claim 13, wherein the operation modes of the first resonant converter and the second resonant converter are independent of each other.

16. The power supply system according to claim 13, wherein the first resonant converter operates in the first operation mode, and the second resonant converter operates in the second operation mode, or
the first resonant converter operates in the second operation mode, and the second resonant converter operates in the first operation mode.

17. A method for switching bidirectional operation of a resonant converter, the resonant converter comprising a first switching circuit, a resonant network and a second switching circuit connected sequentially, the first switching circuit comprising a first port and a second port, the second switching circuit comprising a third port and a fourth port, the resonant network connected between the second port and the third port, the bidirectional operation comprising a first operation mode where power flows from the first switching circuit to the second switching circuit, and a second operation mode where power flows from the second switching circuit to the first switching circuit, the resonant converter comprising a transformer, and a turns ratio of a primary winding and a secondary winding of the transformer being n, wherein when a voltage of the first port is greater than n multiplied by a voltage of the fourth port, the switching method comprises:
in the first operation mode, controlling the first switching circuit and the second switching circuit to operate synchronously; and
in the second operation mode, controlling the first switching circuit to operate with a phase shift relative to the second switching circuit.

18. The method for switching bidirectional operation of a resonant converter according to claim 17, wherein in the second operation mode, controlling the first switching circuit to operate with a phase shift relative to the second switching circuit comprises: controlling the first switching circuit according to a first control signal, and controlling the second switching circuit according to a second control signal, wherein the first control signal is delayed with respect to the second control signal.

19. The method for switching bidirectional operation of a resonant converter according to claim 17, wherein,
in the first operation mode, the first switching circuit performs frequency modulation operation, and the second switching circuit operates synchronously with the first switching circuit; and
in the second operation mode, the second switching circuit performs frequency modulation operation, and the first switching circuit operates lagging behind the second switching circuit.
